(19) United States
(12) Patent Application Publication
(10) Pub. No.: US 2022/0322388 A1
(43) Pub. Date: Oct. 6, 2022

(54) UPLINK (UL) TRANSMIT (TX) SWITCH OPERATIONS

(71) Applicant: QUALCOMM Incorporated, San Diego, CA (US)

(72) Inventors: Kazuki Takeda, Tokyo (JP); Alberto Rico Alvarino, San Diego, CA (US); Umesh Phuyal, San Diego, CA (US)

(21) Appl. No.: 17/653,630

(22) Filed: Mar. 4, 2022

Related U.S. Application Data
(60) Provisional application No. 63/170,424, filed on Apr. 2, 2021.

(51) Int. Cl. H04W 72/12; H04W 72/04

(52) U.S. Cl. CPC H04W 72/1268; H04W 72/1289; H04W 72/048; H04W 72/0453

(57) ABSTRACT

This disclosure provides systems, methods, and devices for wireless communication that support uplink (UL) transmit (Tx) switch operations. In a first aspect, a method of wireless communication includes transmitting a user equipment (UE) capability that indicates multiple bands including a first set of bands and a second set of bands, each of the first set of bands and the second set of bands available for a UL Tx switch configuration. The first set of bands may be a pair of bands or a group of one or more bands. The method also includes receiving the UL Tx switch configuration for the first set of bands or the second set of bands, and transmitting an uplink message via the first set of bands or the second set of bands indicated by the UL Tx switch configuration. Other aspects and features are also claimed and described.

### CROSS-REFERENCE TO RELATED APPLICATIONS

This application claims the benefit of U.S. Provisional Patent Application No. 63/170,424, entitled, “UPLINK (UL) TRANSMIT (TX) SWITCH OPERATIONS,” filed on Apr. 2, 2021, which is expressly incorporated by reference herein in its entirety.

### TECHNICAL FIELD

Aspects of the present disclosure relate generally to wireless communication systems, and more particularly, to uplink (UL) transmit (Tx) switch operations. Some features may enable and provide improved communications, including UL Tx switch for a variety of communication scenarios.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication includes transmitting a UE capability that indicates a first band pair and a second band pair. The method also includes receiving an uplink (UL) transmit (Tx) switch configuration for the first band pair or the second band pair, and transmitting an uplink message via the first band pair or the second band pair indicated by the UL Tx switch configuration.

In an additional aspect of the disclosure, an apparatus includes at least one processor and a memory coupled to the at least one processor. The at least one processor is configured to initiate transmission of a UE capability that indicates a first band pair and a second band pair, receive a UL Tx switch configuration for the first band pair or the second band pair, and initiate transmission of an uplink message via the first band pair or the second band pair indicated by the UL Tx switch configuration.

In an additional aspect of the disclosure, an apparatus includes means for transmitting a UE capability that indicates a first band pair and a second band pair. The apparatus also includes means for receiving a UL Tx switch configuration for the first band pair or the second band pair, and means for transmitting an uplink message via the first band pair or the second band pair indicated by the UL Tx switch configuration.

In an additional aspect of the disclosure, a non-transitory computer-readable medium stores instructions that, when executed by a processor, cause the processor to perform operations. The operations include initiating transmission of a UE capability that indicates a first band pair and a second band pair, receiving a UL Tx switch configuration for the first band pair or the second band pair, and initiating transmission of an uplink message via the first band pair or the second band pair indicated by the UL Tx switch configuration.

In one aspect of the disclosure, a method for wireless communication includes transmitting a UE capability that indicates a first set of bands and a second set of bands. The method also includes receiving a UL Tx switch configuration for the first set of bands or the second set of bands, and transmitting an uplink message via the first set of bands or the second set of bands indicated by the UL Tx switch configuration.

In an additional aspect of the disclosure, an apparatus includes at least one processor and a memory coupled to the at least one processor. The at least one processor is configured to initiate transmission of a UE capability that indicates a first set of bands and a second set of bands, receive a UL Tx switch configuration for the first set of bands or the second set of bands, and initiate transmission of an uplink message via the first set of bands or the second set of bands indicated by the UL Tx switch configuration.

In an additional aspect of the disclosure, an apparatus includes means for transmitting a UE capability that indicates a first set of bands and a second set of bands. The apparatus also includes means for receiving a UL Tx switch configuration for the first set of bands or the second set of bands, and means for transmitting an uplink message via the first set of bands or the second set of bands indicated by the UL Tx switch configuration.

In an additional aspect of the disclosure, a non-transitory computer-readable medium stores instructions that, when executed by a processor, cause the processor to perform operations. The operations include initiating transmission of a UE capability that indicates a first set of bands and a second set of bands, receiving a UL Tx switch configuration for the first set of bands or the second set of bands, and initiating transmission of an uplink message via the first set of bands or the second set of bands indicated by the UL Tx switch configuration.

In one aspect of the disclosure, a method for wireless communication includes receiving a UE capability that indicates a first set of bands and a second set of bands, each of the first set of bands and the second set of bands available for a UL Tx switch configuration. The method also includes transmitting the UL Tx switch configuration for the first set of bands or the second set of bands, and receiving an uplink message via the first set of bands or the second set of bands indicated by the UL Tx switch configuration.

In an additional aspect of the disclosure, an apparatus includes at least one processor and a memory coupled to the at least one processor. The at least one processor is configured to receive a UE capability that indicates a first set of bands and a second set of bands, each of the first set of bands and the second set of bands available for a UL Tx switch configuration, initiate transmission of the UL Tx switch configuration for the first set of bands or the second set of bands, and receive an uplink message via the first set of bands or the second set of bands indicated by the UL Tx switch configuration.

In an additional aspect of the disclosure, an apparatus includes means for receiving a UE capability that indicates a first set of bands and a second set of bands, each of the first set of bands and the second set of bands available for a UL Tx switch configuration. The apparatus also includes means for transmitting the UL Tx switch configuration for the first set of bands or the second set of bands, and means for receiving an uplink message via the first set of bands or the second set of bands indicated by the UL Tx switch configuration.

In an additional aspect of the disclosure, a non-transitory computer-readable medium stores instructions that, when executed by a processor, cause the processor to perform operations. The operations include receiving a UE capability that indicates a first set of bands and a second set of bands, each of the first set of bands and the second set of bands available for a UL Tx switch configuration, initiating transmission of the UL Tx switch configuration for the first set of bands or the second set of bands, and receiving an uplink message via the first set of bands or the second set of bands indicated by the UL Tx switch configuration.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example wireless communication system that supports uplink (UL) transmit (Tx) switch operations according to one or more aspects.

FIG. 4 is a diagram illustrating UE capabilities for UL Tx switch operations according to one or more aspects.

FIG. 5 is a diagram illustrating UE capabilities for UL Tx switch operations according to one or more aspects.

FIG. 6 is a diagram illustrating UE capabilities for UL Tx switch operations according to one or more aspects.

FIG. 7 is a diagram illustrating UE capabilities for UL Tx switch operations according to one or more aspects.

FIG. 8 is a diagram illustrating UE capabilities for UL Tx switch operations according to one or more aspects.

FIG. 9 is a diagram illustrating UE capabilities for UL Tx switch operations according to one or more aspects.

FIG. 10 is a flow diagram illustrating an example process that supports UL Tx switch operations according to one or more aspects.

FIG. 11 is a flow diagram illustrating an example process that supports UL Tx switch operations according to one or more aspects.

FIG. 12 is a flow diagram illustrating an example process that supports UL Tx switch operations according to one or more aspects.

FIG. 13 is a block diagram of an example UE that supports UL Tx switch operations according to one or more aspects.

FIG. 14 is a flow diagram illustrating an example process that supports UL Tx switch operations according to one or more aspects.

FIG. 15 is a block diagram of an example base station that supports UL Tx switch operations according to one or more aspects.

Like reference numbers and designations in the various drawings indicate like elements.

### DETAILED DESCRIPTION

The detailed description and appendix set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜0.99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

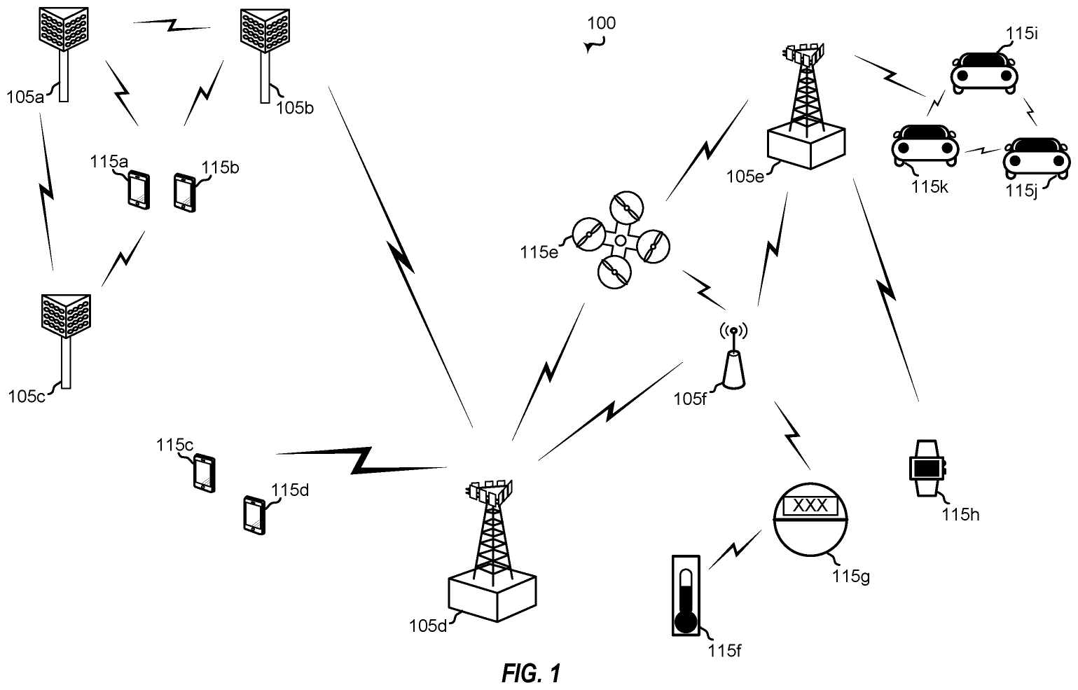

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

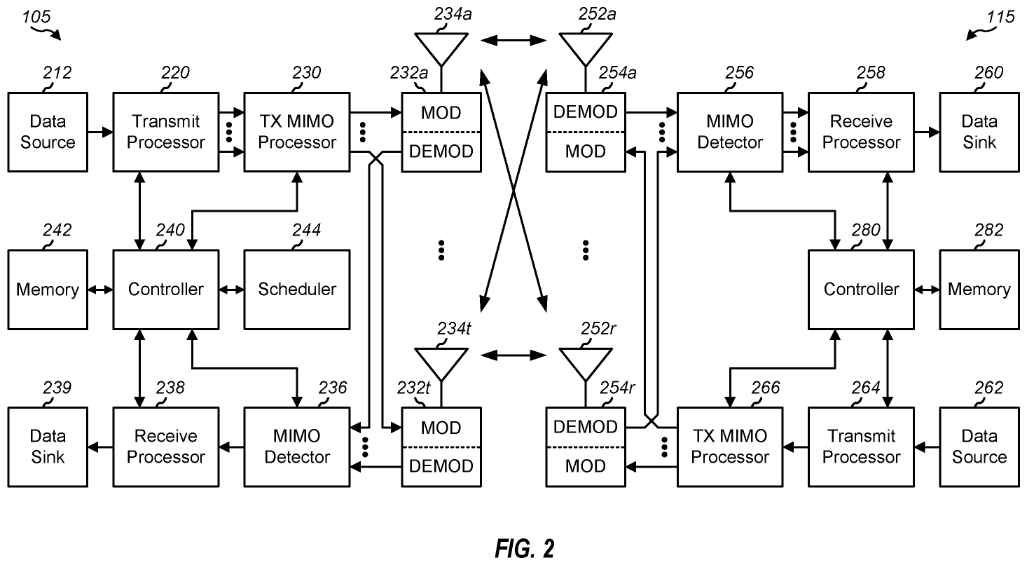

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

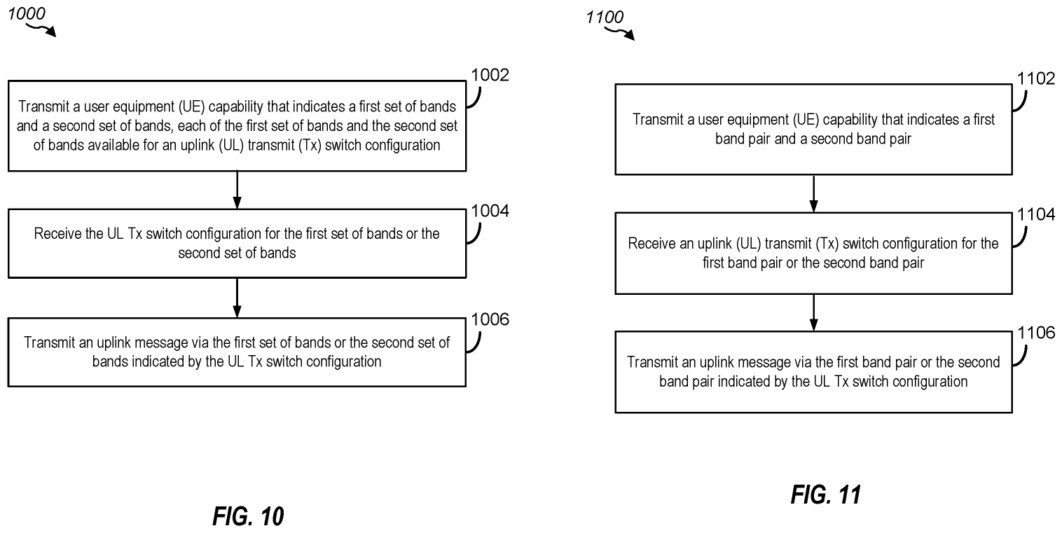

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIG. 10-12 or 14, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

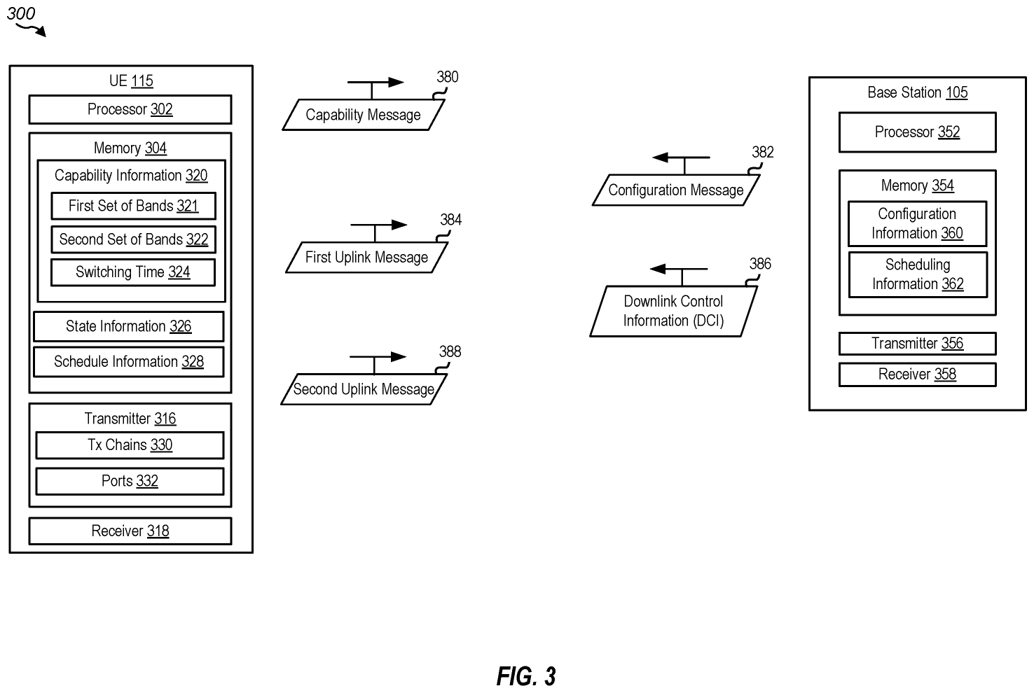

FIG. 3 is a block diagram of an example wireless communications system 300 that supports uplink (UL) transmit (Tx) switch operations according to one or more aspects. In some examples, wireless communications system 300 may implement aspects of wireless network 100. Wireless communications system 300 includes UE 115 and base station 105. Although one UE 115 and one base station 105 are illustrated, in some other implementations, wireless communications system 300 may generally include multiple UEs 115, and may include more than one base station 105.

UE 115 may include a variety of components (such as structural, hardware components) used for carrying out one or more functions described herein. For example, these components may include one or more processors 302 (hereinafter referred to collectively as “processor 302”), one or more memory devices 304 (hereinafter referred to collectively as “memory 304”), one or more transmitters 316 (hereinafter referred to collectively as “transmitter 316”), and one or more receivers 318 (hereinafter referred to collectively as “receiver 318”). Processor 302 may be configured to execute instructions stored in memory 304 to perform the operations described herein. In some implementations, processor 302 includes or corresponds to one or more of receive processor 258, transmit processor 264, and controller 280, and memory 304 includes or corresponds to memory 282.

Memory 304 includes or is configured to store capability information 320, state information 326, and schedule information 328. Capability information 320 is associated with UL Tx switch operations of UE 115. For example, capability information 320 may include or correspond to information for UE capability signaling associated with UL Tx switching operations.

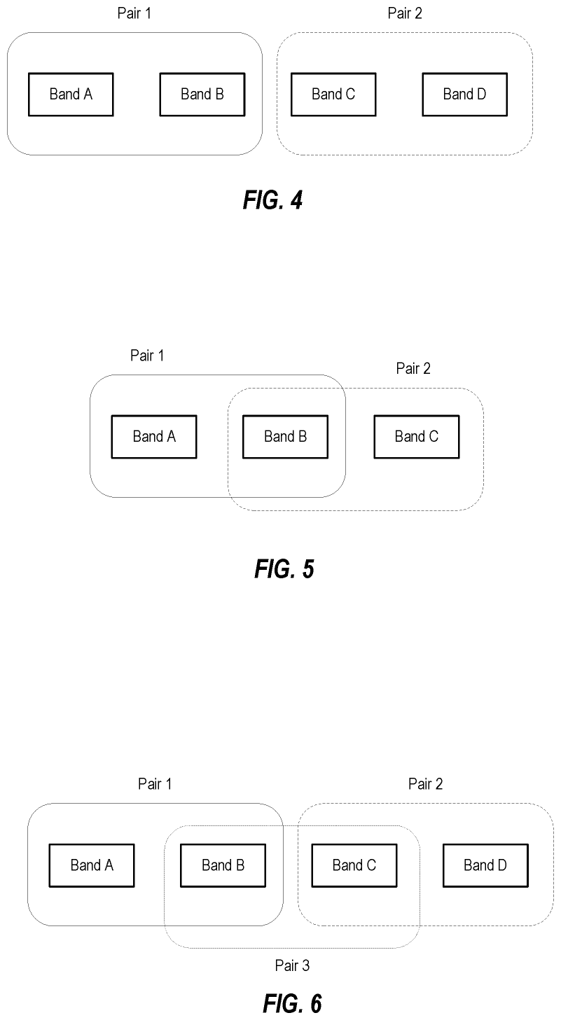

Capability information 320 includes or indicates a first set of bands 321, a second set of bands 322, and a switching time 324. First set of bands 321 may include a first band pair or a first group of one or more bands. Second set of bands 322 may include a second band pair or a second group of one or more bands. In some implementations, first set of bands 321 may include a first band, a first carrier of a second band, a first subcarrier of a third band, or a combination thereof. Accordingly, first set of bands 321 may include a combination of one or more bands, one or more carriers of one or more bands, one or more bandwidth parts (BWPs) of one or more bands, one or more subcarriers of one or more bands, or a combination thereof. Additionally, or alternatively, second set of bands 322 may include a fourth band, a second carrier of a fifth band, a second subcarrier of a sixth band, or a combination thereof. Accordingly, second set of bands 322 may include a combination of one or more bands, one or more carriers of one or more bands, one or more BWPs of one or more bands, one or more subcarriers of one or more bands, or a combination thereof. Examples of first set of bands 321 and second set of bands 321 are described further herein at least with reference to FIGS. 4-9.

Switching time 324 may include, for a set of bands, a period of time (or duration) for UE 115 to switch a configuration to the set of bands from another set of bands, or from the other set of bands to the set of bands. For example, switching time 324 may indicate a first period of time for first set of bands 321, a second period of time for second set of bands 322, or a combination thereof.

In some implementations, capability information 320 indicates a maximum total number of Tx chains or a maximum total number of antenna ports in a set of bands, a maximum number of Tx chains or a maximum number of antenna ports in a set of bands, or a combination thereof. Additionally, or alternatively, capability information 320 indicates one or more fixed Tx chains or one or more fixed antenna ports in a set of bands, one or more distributable Tx chains or one or more distributable antenna ports in a set of bands, or a combination thereof.

State information 326 may indicate a configuration of transmitter 316. For example, state information 326 may indicate a current configuration of one or more Tx chains, one or more ports, or a combination thereof. Schedule information 328 may indicate a subcarrier, a carrier, a band, or a combination thereof, one or more symbols or one or more slots, or a combination thereof, for the UE 115 to transmit an uplink message.

Transmitter 316 is configured to transmit reference signals, control information and data to one or more other devices, and receiver 318 is configured to receive references signals, synchronization signals, control information and data from one or more other devices. For example, transmitter 316 may transmit signaling, control information and data to, and receiver 318 may receive signaling, control information and data from, base station 105. Transmitter 316 include Tx chains 330 and ports 332. In some implementations, transmitter 316 and receiver 318 may be integrated in one or more transceivers. Additionally or alternatively, transmitter 316 or receiver 318 may include or correspond to one or more components of UE 115 described with reference to FIG. 2.

Base station 105 may include a variety of components (such as structural, hardware components) used for carrying out one or more functions described herein. For example, these components may include one or more processors 352 (hereinafter referred to collectively as “processor 352”), one or more memory devices 354 (hereinafter referred to collectively as “memory 354”), one or more transmitters 356 (hereinafter referred to collectively as “transmitter 356”), and one or more receivers 358 (hereinafter referred to collectively as “receiver 358”). Processor 352 may be configured to execute instructions stored in memory 354 to perform the operations described herein. In some implementations, processor 352 includes or corresponds to one or more of receive processor 238, transmit processor 220, and controller 240, and memory 354 includes or corresponds to memory 242.

Memory 354 includes or is configured to store configuration information 360 and scheduling information 362. Configuration information 360 includes a configuration for the UE 115 to transmit one or more uplink messages. In some implementations, configuration information 360 is includes or is generated based on capability information 320. Scheduling information 362 may include or correspond to schedule information 328.

Transmitter 356 is configured to transmit reference signals, synchronization signals, control information and data to one or more other devices, and receiver 358 is configured to receive reference signals, control information and data from one or more other devices. For example, transmitter 356 may transmit signaling, control information and data to, and receiver 358 may receive signaling, control information and data from, UE 115. In some implementations, transmitter 356 and receiver 358 may be integrated in one or more transceivers. Additionally or alternatively, transmitter 356 or receiver 358 may include or correspond to one or more components of base station 105 described with reference to FIG. 2.

In some implementations, wireless communications system 300 implements a 5G NR network. For example, wireless communications system 300 may include multiple 5G-capable UEs 115 and multiple 5G-capable base stations 105, such as UEs and base stations configured to operate in accordance with a 5G NR network protocol such as that defined by the 3GPP.

During operation of wireless communications system 300, UE 115 generates a capability message 380 that indicates a UE capability of UE 115, such as which sets of bands can be enabled simultaneously for UL Tx switch operations. For example, capability message 380 may include at least a portion of capability information 320. To illustrate, capability message 380 may indicate first set of bands 321 and second set of band 322. In some implementations, the capability message 380 indicates multiple bands, such as a set of multiple bands that includes first set of bands 321 and second set of bands 322. In some such implementations, first set of bands 321 may include a first band pair or a first group of one or more bands, and second set of bands 322 may include a second band pair or a second group of one or more bands.

In some implementations, capability message 380, such as the UE capability, indicates a first switching time of switching time 324 for first set of bands 321, a second switching time of switching time 324 for second set of bands 322, or a combination thereof. Additionally, or alternatively, capability message 380, such as the UE capability, may indicate a maximum total number of Tx chains or a maximum total number of antenna ports in set of bands, a maximum number of Tx chains or a maximum number of antenna ports in a set of bands, one or more fixed Tx chains or one or more fixed antenna ports in a set of bands, one or more distributable Tx chains or one or more distributable antenna ports in a set of bands, or a combination thereof.

Base station 105 receives capability message 380 and determines configuration information 360 for UE 115 based on capability message 380. Configuration information 360 includes a configuration, such as a UL Tx switch configuration for first set of bands 321 or second set of bands 322, for the UE 115 to transmit one or more uplink messages. In some implementations, base station 105 stores capability information associated with the UE 115 at memory 354. Base station 105 generates a configuration message 382 based on the configuration information 306 and transmits the configuration message 382. Additionally, or alternatively, configuration message 382 (or another message) may include scheduling information, such as at least a portion of scheduling information 362, for UE 115 to transmit one or more uplink messages using the configuration indicated by configuration message 382. In some implementations, capability message 380, configuration message 382, or a combination thereof, may be associated with radio resource control (RRC) messaging between UE 115 and base station 105.

UE 115 receives configuration message 382 and identifies the configuration, such as the UL Tx switch configuration, indicated by configuration message 382. For example, the configuration may be a configuration for first set of bands 115 to be used to transmit one or more uplink messages.

Based on the configuration, such as the UL Tx switch configuration, indicated by configuration message 382, UE may set state information 326, configured transmitter 316, or a combination thereof. To illustrate, UE 115 may store, at memory 304 and based on the received UL Tx switch configuration, first data to indicate that first set of bands 321 is to be used for uplink communication. As another example, UE may configure, based on the received UL Tx switch configuration, a Tx chain of Tx chains 330, a port of ports 332, or a combination thereof, to enable uplink communication via first set of bands 321.

After setting state information 326, configuring transmitter 316, or a combination thereof, UE 115 transmits a first uplink message 384 vis first set of bands 321 indicated by the UL Tx switch configuration. In some implementations, UE 115 may transmit first uplink message 384 according to schedule information 328.

Base station 105 receives first uplink message 384. After reception of first uplink message 384 via first set of bands 321, base station 105 generates DCI 386 for dynamic UL Tx switching. Base station 105 may generate DCI 386 based on configuration information 360, UE capability information received form UE 115, scheduling information 362, or a combination thereof. In some implementations, DCI 386 includes or indicates a new configuration for UE 115, schedule information for transmission of one or more UL messages using the new configuration, or a combination thereof. The base station 105 transmits DCI 386 to UE 115.

UE 115 receives DCI 386 and, based on DCI 386, determines the new configuration, schedule information, or a combination thereof. In some implementations, the new configuration includes a configuration to use second set of bands 322, the schedule information indicates to transmit one or more UL messages via second set of bands 322, or a combination thereof. Based on DCI 386, UE 115 may store or update schedule information 328, switch from a first uplink communication configuration (for first set of bands 321) to a second uplink configuration (for second set of bands 322). To switch the uplink communication configuration, UE 115 may update memory 304 to store second data indicating that the second set of bands is to be used for uplink communication. For example, UE 115 may store the second data as state information 326. Additionally, or alternatively, to switch the uplink communication configuration, UE 115 may configure transmitter, such as one or more Tx chains of Tx chains 330, one or more ports of ports 32, or a combination thereof, to enable uplink communication via second set of bands 322.

After switching the uplink communication configuration, UE 115 transmits a second uplink message 388 via second set of bands 322. For example, UE 115 may transmit second uplink message 388 based on or in accordance with schedule information 328. In some implementations, no uplink transmissions are scheduled for UE 115 during a switching period associated with switching from first set of bands 321 to second set of bands 322, or a scheduled transmission for UE 115 during the switching period (associated with switching from first set of bands 321 to second set of bands 322) is dropped and not transmitted. Alternatively, UE 115 may transmit second uplink message 388 during a switching period (associated with switching from first set of bands 321 to second set of bands 322) when an uplink communication transmission is scheduled for transmission via a band included in both first set of bands 321 and second set of bands 322.

In some implementations, UE capability signaling for UL Tx switch operations may indicate multiple pairs of bands to enable UL Tx switching for the multiple band pairs, not just so that UL Tx switch is carried out only from one band to another band on one of the pairs of bands as in conventional techniques. For example, the UE capability signaling may indicate a first pair that includes a first band (band A) and a second band (band b), and a second pair includes a third band (band c) and a fourth band (band d). Additionally, or alternatively, the UE capability may indicate a third pair that includes the second band (band b) and the third band (band c). The UE capability may enable UL Tx switching for the multiple band pairs, such as the first band pair and the second band pair, or the first band pair, the second band pair, and the third band pair. Stated in a different manner, by transmitting the UE capability, the UE, such as UE 115, reports for which set of pairs can be enabled simultaneously. The UE capability may also indicate a switch time to switch from one band pair to another band pair.

A network (NW), such as base station 105), may configure a UL Tx switch for the first pair, the second pair, or the third pair via a higher-layer configuration. For example, the higher layer configuration may include or correspond to DCI 386.

The pairs indicated by the UE capability signaling, such as capability message 380, may contain a common band or may contain two different bands. In some implementations, the UE capability signaling may also indicate a switching period for or within one or more band pairs of the band pairs indicated by the UE capability signaling. To illustrate, for the first pair and the second pair, the UE capability signaling may indicate a first switching period for the first pair, such as a switching period between band a and band b, or a second switching period for the second pair, such as a switching period between band c and band d. Stated in a different manner, simultaneous transmissions on one band of the first pair and one band of the second pair does not require a switching period. It is noted that to ensure the switching period between one band, such as band b of the first pair, and one band, such as band c, of the second pair, the UE may report additional band pairs, such as (e.g., band C) of pair 2, the UE can report additional set(s) of pairs. To illustrate, the UE capability may indicate the first pair, the second pair, and the third pair.

The NW, such as the base station 105, configures a UL Tx switch for a band pair. It is noted that each band reported by the UE capability signaling belongs to one or more band pairs.

In some implementations, if the UL Tx chains for a scheduled or configured UL transmission on one or more bands of a pair of bands is different from a current state of the UL Tx chains, such as a current state as indicated by state information 326, the UE may perform a UL Tx switch operation. It is noted that the NW may refrain from scheduling any UL transmission, or the UE drop a UL transmission (if there is UL transmission pending or scheduled) during the switching period. Alternatively, if the UL transmission is for a common band (of the current state and of a next state), the UE may transmit the UL transmission via the common band during the switching period.

In some implementations, the UL Tx switch operation is associated with a switch from or to more than one band. For example, the UE capability signaling may indicate a set of bands instead of a pair of bands, for the UL Tx switch. In the indicated set of bands, one or more bands of the set of bands may form a group of bands. It is noted that each band in a set belongs to one or more groups of the set. Additionally, the set of bands may include multiple groups of one or more bands and UL Tx switch is carried out between the groups. In some implementations, the UE capability signaling may indicate multiple groups of one or more bands, such as a first group and a second group. In some implementations, the UE capability signaling may also indicate a switching period of time between UL transmissions between different groups, such as a first group and a second group.

The NW, such as base station 105), may configure a UL Tx switch operation. In some implementations, if the UL Tx chains for a scheduled or configured UL transmission on one or more bands of a group is different from a current state of the UL Tx chains, such as a current state as indicated by state information 326, the UE may perform a UL Tx switch operation. It is noted that the NW may refrain from scheduling any UL transmission, or the UE drop a UL transmission (if there is UL transmission pending or scheduled) during the switching period. Alternatively, if the UL transmission is for a common band (of the current state and of a next state), the UE may transmit the UL transmission via the common band during the switching period.

In some implementations, if there is one or multiple bands where the state of the Tx chain(s) is unchanged based on a UL Tx switch operation, the UE may operate according to at least a first operation or a second option. According to the first option, during the switching period, UL transmission does not occur even on the band with unchanged Tx chain(s). According to the second option, the switching period is not applicable to the band with unchanged Tx chain(s) and the UE may transmit an UL message on the band during the switching period. It is noted that UL Tx switching may be trigged by the UE based on a current state, such as the state information 326, of the Tx chain(s), based on a UL transmission that is scheduled or configured for one or bands, or a combination thereof.

In some implementations, if a band is common between two groups, the number of Tx chains (or the number of antenna ports) maybe different. In such scenarios, the UE may consider the state of the Tx chains as being changed (e.g., having to be changed) and may perform UL Tx switching.

In some implementations, when UE capability signaling indicate multiple band pairs or multiple groups, UE 115 may also report its capability of how UL Tx chains (or UL antenna ports) can be distributed across uplink carriers (or sub-carrier or BWP) in each state. For example, the UE capability signaling may indicate a maximum total number of Tx chains (or antenna ports) in a group or in a pair, a maximum number of Tx chains (or antenna ports) in a band of a group or of a pair, fixed Tx chains (or antenna ports) in a group or in a pair, distributable Tx chains (or antenna ports) in a group or in a pair, or a combination thereof. It is noted that for some bands, one or more or more Tx chains maybe fixed and cannot be distributed regardless of the state of UL Tx chains.

It is noted that although FIG. 3 has been described with reference to a set of bands, such as a pair of bands or a group of one or more bands, a band may include multiple carriers, one or more BWPs of one or more bands, one or more subcarriers, or a combination thereof. In such situations, different carriers or sub-carrier in a band may have different Tx chains or may belong to different sets of bands, different band pairs, or different groups. Accordingly, it is understood that the UE capability signaling, the higher layer configuration (e.g., DCI), or a combination thereof may be implemented as per-carrier or carrier level, per-BWP or BWP level, or per-sub-carrier or sub-carrier-level.

In some implementations, the UE capability signaling described herein may be used for conventional UL Tx switch operations, such as UL Tx switch operations described with reference to Rel. 16, or other non-conventional UL Tx switch operations. In some such implementations, the UE capability signaling may indicate one or more types of UL Tx switch operations supported by the UE.

The UE capability signaling described herein may be used to allow switching for two uplink carries for inter-band UL CA, SUL without EN-DC, or inter-band EN-DC without SUL. In some implementations, for EN-DC and inter-band UL CA, two different option may be support, such as a switched UL option and a dual UL option. Additionally, or alternatively, the UE capability signaling described herein may be implemented with a memory-based UL Tx switching scheme. In memory-based UL Tx switching, if there is no UL transmission, the ‘state’ of Tx chain of a most recent UL transmission is maintained until a next transmission. An example of a memory-based UL Tx switching scheme is the UL Tx switching scheme for Dual UL of inter-band UL CA as implemented in Rel. 16.

In some implementations, the UE capability signaling described herein may be used for UL TX switch with two uplink carriers in inter-band UL CA and SUL. Additionally, or alternatively, the UE capability signaling described herein may be used for UL Tx switch with 3 uplink carriers in inter-band UL CA and SUL where 2 of the uplink carriers are contiguous in the same band. Additionally, or alternatively, the UE capability signaling described herein may be used for three or more uplink carriers over three or more bands, for the UE is able to transmit simultaneously on a subset of (but more than two) uplink carriers, or a combination thereof.

As described with reference to FIG. 3, the present disclosure provides techniques for UL Tx switch operations. For example, the present disclosure may enable and provide improved communications, including UL Tx switch for a variety of communication scenarios. To illustrate, UE capability signaling may indicate a set of multiple bands. In some implementations, the set of multiple bands may include a first band pair and a second band pair. The multiple band pairs may enable UL Tx switching for the multiple band pairs, not just so that UL Tx switch is carried out only from one band to another band on one of the pairs of bands as in conventional techniques. Accordingly, the UE capability signaling may indicate multiple band pairs that can be enabled or used for UL Tx switching. As another example, the set of multiple bands may include or indicate multiple groups of bands, such as a first group of one or more bands and a second group of one or more bands. Each group of one or more bands may be enabled or used for UL Tx switching. Accordingly, the techniques describes herein may be used for UE capability signaling, UL Tx switching, or both and may support conventional UL Tx switching and additional UL Tx switching schemes or operations.

Referring to FIGS. 4-9, each of FIGS. 4-9 is a diagram illustrating UE capabilities for UL Tx switch operations according to one or more aspects. The UE capabilities may include or correspond to capability information 320, capability message 380, or a combination thereof.

FIG. 4 shows a first band pair (Pair 1) and a second band pair (Pair 2). The first band pair may include or correspond to first set of bands 321 and the second band pair may include or correspond to second set of bands 321. The first band pair (Pair 1) includes a first band (Band A) and a second band (Band B). The second band pair (Pair 2) includes a third band (Band C) and a fourth band (Band D).

FIG. 5 shows a first band pair (Pair 1) and a second band pair (Pair 2). The first band pair may include or correspond to first set of bands 321 and the second band pair may include or correspond to second set of bands 321. The first band pair (Pair 1) includes a first band (Band A) and a second band (Band B). The second band pair (Pair 2) includes the second band (Band B) and a third band (Band C).

FIG. 6 shows a first band pair (Pair 1), a second band pair (Pair 2), and a third band pair (Pair 3). The first band pair may include or correspond to first set of bands 321. The second band pair or the third band pair may include or correspond to second set of bands 321. The first band pair (Pair 1) includes a first band (Band A) and a second band (Band B). The second band pair (Pair 2) includes a third band (Band C) and a fourth band (Band D). The third band pair (Pair 3) includes the second band (Band B) and the third band (Band C).

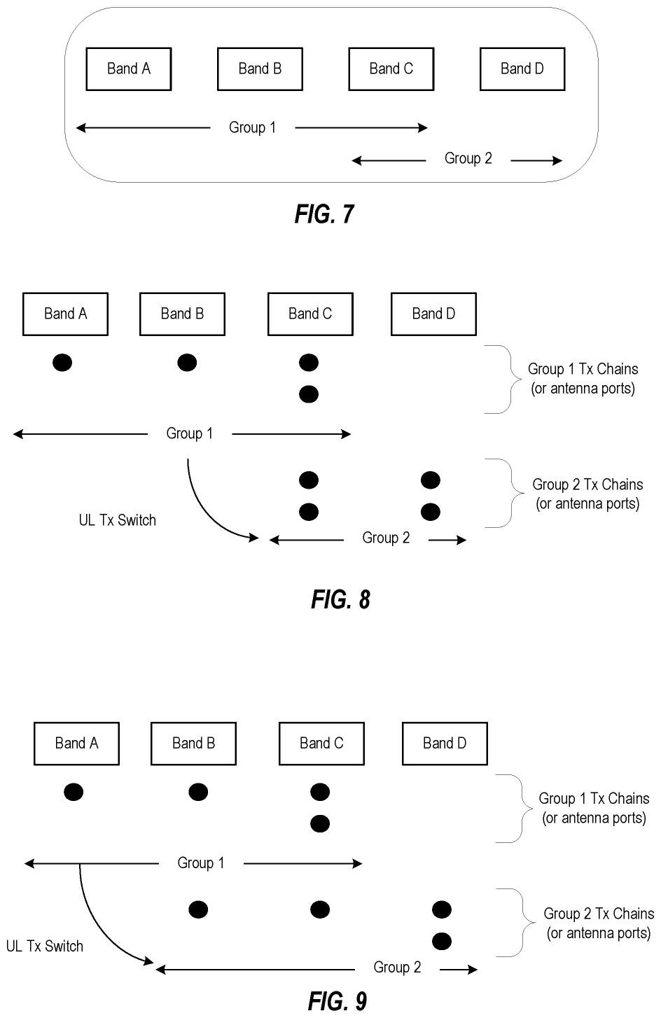

FIG. 7 shows a first group of bands (Group 1) and a second group of bands (Group 2). The first group of bands may include or correspond to first set of bands 321 and the second group of bands may include or correspond to second set of bands 321. The first group of bands (Group 1) includes a first band (Band A), a second band (Band B), and a third band (Band C). The second group of bands (Group 2) includes the third band (Band C) and a fourth band (Band D). Although FIG. 7 shows two groups of bands, in other implementations, there may be more than two groups of bands.

In other implementations, the first group of bands (Group 1) may include one or more bands. Additionally or alternatively, the second group of bands (Group 2) may include one or more bands. The first group of bands and the second group of bands may have one or more common bands or may not have any common bands.

In some implementations, one or more groups of bands may also include a corresponding Tx chain configuration, a corresponding antenna port configuration, or a combination thereof. For example, the first group of bands (Group 1) may include a first Tx chain configuration or a first antenna port configuration, the second group of bands (Group 2) may include a second Tx chain configuration or a second antenna port configuration, or a combination thereof. To illustrate, one or more Tx chain configurations (or one or more antenna port configurations) are described further herein at least with reference to FIGS. 8 and 9.

FIG. 8 shows a first group of bands (Group 1) and a second group of bands (Group 2). The first group of bands may include or correspond to first set of bands 321 and the second group of bands may include or correspond to second set of bands 321. The first group of bands (Group 1) includes a first band (Band A), a second band (Band B), and a third band (Band C). The second group of bands (Group 2) includes the third band (Band C) and a fourth band (Band D). Although FIG. 7 shows two groups of bands, in other implementations, there may be more than two groups of bands.

The first group of bands (Group 1) is associated with a first Tx chain configuration and the second group of bands (Group 2) is associated with a second Tx chain configuration. The first Tx chain configuration indicates a first Tx chain for the first band (Band A), a second Tx chain for the second band (Band B), and a third Tx chain and a fourth Tx chain for the third band (Band C). The second Tx chain configuration indicates two Tx chains for the third band (Band C) and two Tx chains for the fourth band (Band D).

As shown in FIG. 7, a UL Tx switch operation may be performed to switch from the first group (Group 1) to the second group (Group 2). The switching from the first group (Group 1) to the second group (Group 2) may be associated with a switching period. If a UE, such as UE 115 is scheduled to transmit an uplink message via a band of the second group (Group 2), the UE may determine whether or not the UE may transmit the UL message during the switching period. To illustrate, the UE may determine whether a Tx chain of the first group (Group 1) is common with a Tx chain of the second group (Group 2). If there is no common Tx chain, the UE does not transmit the UL message during the switching period. Alternatively, if there is a common Tx chain between the first group and the second group, the UE may transmit the UL message via the common Tx chain during the switching period. For example, one of the Tx chains of the third band (Band C) is common to the first group and the second group. In some implementations, the UE may determine whether the UL message is scheduled for a particular Tx chain or a particular band. If the particular Tx chain or band is not the common Tx chain, the UE does not transmit the UL message during the switching period. Alternatively, if the particular Tx chain is the common Tx chain or band, the UE may transmit the UL message via the common Tx chain or band during the switching period. For example, if the particular band is the third band (Band C), the Tx chains of the third band (Band C) is common to the first group and the second group.

FIG. 9 shows a first group of bands (Group 1) and a second group of bands (Group 2). The first group of bands may include or correspond to first set of bands 321 and the second group of bands may include or correspond to second set of bands 321. The first group of bands (Group 1) includes a first band (Band A), a second band (Band B), and a third band (Band C). The second group of bands (Group 2) includes the second band (Band B), the third band (Band C) and a fourth band (Band D). Although FIG. 7 shows two groups of bands, in other implementations, there may be more than two groups of bands.

The first group of bands (Group 1) is associated with a first Tx chain configuration and the second group of bands (Group 2) is associated with a second Tx chain configuration. The first Tx chain configuration indicates a first Tx chain for the first band (Band A), a second Tx chain for the second band (Band B), and a third Tx chain and a fourth Tx chain for the third band (Band C). The second Tx chain configuration indicates one Tx chain for the second band (Band B), one Tx chain for the third band (Band C), and two Tx chains for the fourth band (Band D).

As shown in FIG. 8, a UL Tx switch operation may be performed to switch from the first group (Group 1) to the second group (Group 2). The switching from the first group (Group 1) to the second group (Group 2) may be associated with a switching period. If a UE, such as UE 115 is scheduled to transmit an uplink message via a band of the second group (Group 2), the UE may determine whether or not the UE may transmit the UL message during the switching period. To illustrate, the UE may determine whether a Tx chain of the first group (Group 1) is common with a Tx chain of the second group (Group 2). If there is no common Tx chain, the UE does not transmit the UL message during the switching period. Alternatively, if there is a common Tx chain between the first group and the second group, the UE may transmit the UL message via the common Tx chain during the switching period. For example, the Tx chain of the second band (Band B) and one of the Tx chains of the third band (Band C) is common to the first group and the second group. In some implementations, the UE may determine whether the UL message is scheduled for a particular Tx chain or a particular band. If the particular Tx chain or band is not the common Tx chain, the UE does not transmit the UL message during the switching period. Alternatively, if the particular Tx chain is the common Tx chain or band, the UE may transmit the UL message via the common Tx chain or band during the switching period. For example, if the particular band is the second band (Band B) or the third band (Band C), each of the second band (Band B) and the third band (Band C) have one Tx chain common between the first group and the second group. In some implementation, if a number of Tx chains or antenna ports for a band is different between the first group and the second group, the UE may not transmit via the band during the switching period. To illustrate, the UE may transmit via the second band (Band B) but may not transmit via the third band (Band C) during the switching period.

FIG. 10 is a flow diagram illustrating an example process 1000 that supports UL Tx switch operations according to one or more aspects. Operations of process 1000 may be performed by a UE, such as UE 115 described above with reference to FIGS. 1, 2, 3, or a UE described with reference to FIG. 13. For example, example operations (also referred to as “blocks”) of process 1000 may enable UE 115 to support UL Tx switch operations.

In block 1002, the UE transmits a UE capability that indicates a first set of bands and a second set of bands, each of the first set of bands and the second set of bands available for a UL Tx switch configuration. For example, UE capability may include or correspond to capability message 380. The first set of bands and the second set of bands may include or correspond to first set of bands 321 and second set of bands 322, respectively. In some implementations, the first set of bands is a first band pair, and the second set of bands a second band pair. Alternatively, in some other implementations, the first set of bands includes a first group of one or more bands, and the second set of bands includes a second group of one or more bands.

In some implementations, the UE capability indicates which sets of bands can be enabled simultaneously. Additionally, or alternatively, the UE capability may further indicates a maximum total number of Tx chains or a maximum total number of antenna ports in a set of bands, a maximum number of Tx chains or a maximum number of antenna ports in a set of bands, one or more fixed Tx chains or one or more fixed antenna ports in a set of bands, one or more distributable Tx chains or one or more distributable antenna ports in a set of bands, or a combination thereof.

In some implementations, the first set of bands includes a first set of carriers. To illustrate, the first set of carriers may include a first carrier of a first band, a second carrier of a second band, or a combination thereof. Additionally, in some implementations, the first band and the second band are the same band.

In some implementations, the first set of bands may include a first band, a first carrier of a second band, a first subcarrier of a third band, or a combination thereof. Accordingly, the first set of bands may include a combination of one or more bands, one or more carriers of one or more bands, one or more BWPs of one or more bands, one or more subcarriers of one or more bands, or a combination thereof. Additionally, or alternatively, the second set of bands may include a fourth band, a second carrier of a fifth band, a second subcarrier of a sixth band, or a combination thereof. Accordingly, the second set of bands may include a combination of one or more bands, one or more carriers of one or more bands, one or more BWPs of one or more bands, one or more subcarriers of one or more bands, or a combination thereof.

In block 1004, the UE receives the UL Tx switch configuration for the first set of bands or the second set of bands. For example, the UL Tx switch configuration may include or correspond to configuration message 382.

In block 1006, the UE transmits an uplink message via the first set of bands or the second set of bands indicated by the UL Tx switch configuration. For example, the uplink message may include or correspond to first uplink message 384.

In some implementations, no uplink transmissions are scheduled for the UE during a switching period associated with switching from the first set of bands to the second set of bands or a scheduled transmission for the UE during the switching period is dropped and not transmitted. Alternatively, in some other implementations, the UE transmits a second uplink communication during a switching period associated with switching from the first set of bands to the second set of bands when the second uplink communication transmission is scheduled for transmission via a band (or carrier or subcarrier) included in both the first set of bands and the second set of bands.

FIG. 11 is a flow diagram illustrating an example process 1100 that supports UL Tx switch operations according to one or more aspects. Operations of process 1100 may be performed by a UE, such as UE 115 described above with reference to FIGS. 1, 2, 3, or a UE described with reference to FIG. 13. For example, example operations (also referred to as “blocks”) of process 1100 may enable UE 115 to support UL Tx switch operations.

In block 1102, the UE transmits a UE capability that indicates a first band pair and a second band pair. For example, UE capability may include or correspond to capability message 380. The first set of bands and the second set of bands may include or correspond to first set of bands 321 and second set of bands 322, respectively. In some implementations, the UE capability indicates which set of pairs can be enabled simultaneously. Additionally, or alternatively, the UE capability indicates a first switching time for the first band pair, a second switching time for the second band pair, or a combination thereof. The first switching item or the second switching time may include or correspond to switching time 324. Additionally, or alternatively, the UE capability may further indicates a maximum total number of Tx chains or a maximum total number of antenna ports in a set of bands, a maximum number of Tx chains or a maximum number of antenna ports in a set of bands, one or more fixed Tx chains or one or more fixed antenna ports in a set of bands, one or more distributable Tx chains or one or more distributable antenna ports in a set of bands, or a combination thereof.

In block 1104, the UE receives a UL Tx switch configuration for the first band pair or the second band pair. For example, the UL Tx switch configuration may include or correspond to configuration message 382.

In block 1106, the UE transmits an uplink message via the first band pair or the second band pair indicated by the UL Tx switch configuration. For example, the uplink message may include or correspond to first uplink message 384. In some implementations, the UL Tx switch configuration is for the first band pair and the uplink message is transmitted via the first band pair based on the UL Tx switch configuration.

In some implementations, the UE stores, at a memory and based on the received UL Tx switch configuration, first data to indicate that the first band pair is to be used for uplink communication. The memory may include or correspond to memory 304. To illustrate, the first data may be stored as state information 326.

In some implementations, the UE configures a Tx chain, a port, or a combination thereof, to enable uplink communication via the first band pair. The Tx chain and the port may include or correspond to Tx chains 330 and ports 332, respectively.

In some implementations, after transmitting the uplink message via the first band pair, the UE receives DCI to schedule a transmission via the second band pair. The DCI may include or correspond to DCI 386. The UE may transmit, based on the DCI, a second uplink message via the second band pair. The second uplink message may include or correspond to second uplink message 388.

In some implementations, the UE switches, based on the DCI, from a first uplink communication configuration for the first band pair to a second uplink communication configuration for the second band pair. To switch from first uplink communication configuration to the second uplink communication configuration the UE may update a memory, such as memory 304, to store second data indicating that the second band pair is to be used for uplink communication. The second data may include or correspond to state information 326. Additionally, in some implementations, To switch from first uplink communication configuration to the second uplink communication configuration the UE may configure the Tx chain, the port, or a combination thereof to enable uplink communication via the second band pair, or a combination thereof.

In some implementations, no uplink transmissions are scheduled for the UE during a switching period associated with switching from the first band pair to the second band pair or a scheduled transmission for the UE during the switching period is dropped and not transmitted. Alternatively, the UE may transmit a second uplink communication during a switching period associated with switching from the first band pair to the second band pair when the second uplink communication transmission is scheduled for transmission via a band included in both the first band pair and the second band pair.

In some implementations, the first band pair includes a first band and a second band, and the second band pair includes a third band and a fourth band. The second band and the third band may be the same band or may be different bands. In some other implementations, the UE capability further indicates a third band pair which includes a fifth band and a sixth band. The second band and the fifth band may be the same band or different bands, the third band and the sixth band may be the same band or different bands, or a combination thereof.

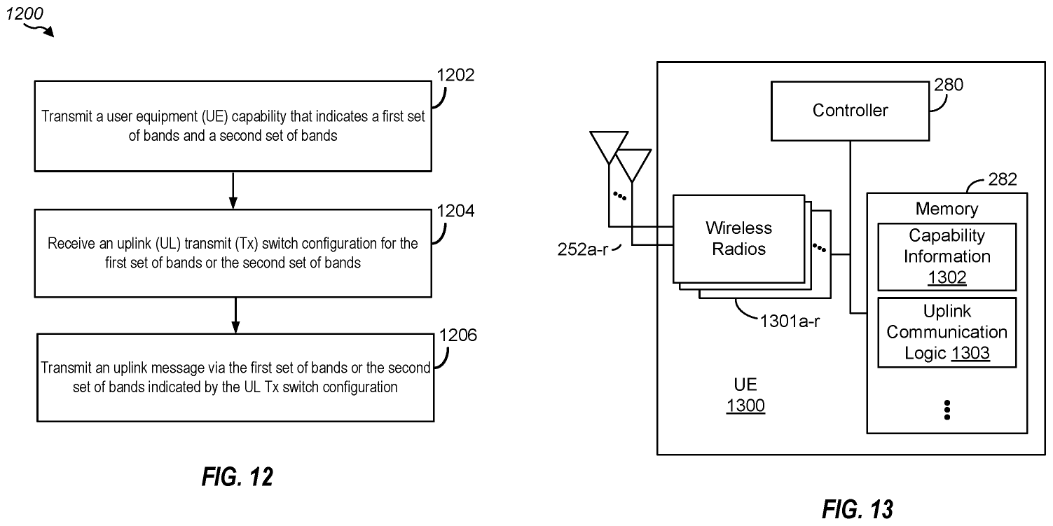

FIG. 12 is a flow diagram illustrating an example process 1200 that supports UL Tx switch operations according to one or more aspects. Operations of process 1200 may be performed by a UE, such as UE 115 described above with reference to FIGS. 1, 2, 3, or a UE described with reference to FIG. 13. For example, example operations (also referred to as “blocks”) of process 1200 may enable UE 115 to support UL Tx switch operations.

In block 1202, the UE transmits a UE capability that indicates a first set of bands and a second set of bands. For example, UE capability may include or correspond to capability message 380. The first set of bands and the second set of bands may include or correspond to first set of bands 321 and second set of bands 322, respectively. The UE capability may indicate multiple sets of bands that are available for the UL Tx switch configuration In some implementations, the UE capability indicates which sets of bands can be enabled simultaneously.

In some implementations, the UE capability indicates a first switching time for the first set of bands, a second switching time for the second set of bands, or a combination thereof. Additionally, or alternatively, the UE capability may further indicates a maximum total number of Tx chains or a maximum total number of antenna ports in a set of bands, a maximum number of Tx chains or a maximum number of antenna ports in a set of bands, one or more fixed Tx chains or one or more fixed antenna ports in a set of bands, one or more distributable Tx chains or one or more distributable antenna ports in a set of bands, or a combination thereof.

In block 1204, the UE receives a UL Tx switch configuration for the first set of bands or the second set of bands. For example, the UL Tx switch configuration may include or correspond to configuration message 382.

In block 1206, the UE transmits an uplink message via the first set of bands or the second set of bands indicated by the UL Tx switch configuration. For example, the uplink message may include or correspond to first uplink message 384. In some implementations, the UL Tx switch configuration is for the first set of bands and the uplink message is transmitted via the first set of bands based on the UL Tx switch configuration.

In some implementations, the first set of bands includes a first group of one or more bands, and the second set of bands includes a second group of one or more bands. For example, the first group of one or more bands may include a single band, and the second group of one or more bands may include two or more bands. As another example, each of the first group of one or more bands and the second group of one or more bands may include multiple bands. In some implementation, the UE capability further indicates a third set of bands. Additionally, or alternatively, the second group of bands may include three or more bands.

In some implementations, a first band is included in each of the first group of one or more bands and the second group of one or more bands. Additionally, or alternatively, a second band is included in each of the first group of one or more bands and the second group of one or more bands.

In some implementations, the first group of one or more bands includes a first band and a first number of ports allocated to the first band, and the second group includes a second band and a second number of ports allocated to the second band. In some such implementations, the first band and the second band are the same band. Additionally, or alternatively, the first number of ports may be different from the second number of ports, or a combination thereof.

In some implementations, the UE stores, at a memory and based on the received UL Tx switch configuration, first data to indicate that the first set of bands is to be used for uplink communication. For example, the memory may include or correspond to memory 304. The first data may include or correspond to state information 326.

In some implementations, the UE configuring a Tx chain, a port, or a combination thereof, to enable uplink communication via the first set of bands. The Tx chain and the port may include or correspond to Tx chains 330 and ports 332 respectively.

In some implementations, after transmitting the uplink message via the first set of bands, the UE receive DCI to schedule a transmission via the second set of bands. The DCI may include or correspond to DCI 386. The UE may transmit, based on the DCI, a second uplink message via the second set of bands. For example, the second uplink message may include or correspond to second uplink message 388. In some implementations, the UE switches, based on the DCI, from a first uplink communication configuration for the first set of bands to a second uplink communication configuration for the second set of bands. To switch from first uplink communication configuration to the second uplink communication configuration, the UE may update the memory, such as the memory 304, to store second data indicating that the second set of bands is to be used for uplink communication. The second data may include or correspond to state information 326. Additionally, or alternatively, to switch from first uplink communication configuration to the second uplink communication configuration, the UE may configure the Tx chain, the port, or a combination thereof to enable uplink communication via the second set of bands.

In some implementations, no uplink transmissions are scheduled for the UE during a switching period associated with switching from the first set of bands to the second set of bands or a scheduled transmission for the UE during the switching period is dropped and not transmitted. Alternatively, the UE may transmit a second uplink communication during a switching period associated with switching from the first set of bands to the second set of bands when the second uplink communication transmission is scheduled for transmission via a band included in both the first set of bands and the second set of bands.

FIG. 13 is a block diagram of an example UE 1300 that supports UL Tx switch operations to one or more aspects. UE 1300 may be configured to perform operations, including the blocks of one or more processes described with reference to FIGS. 10-12. In some implementations, UE 1300 includes the structure, hardware, and components shown and described with reference to UE 115 of FIGS. 1-3. For example, UE 1300 includes controller 280, which operates to execute logic or computer instructions stored in memory 282, as well as controlling the components of UE 1300 that provide the features and functionality of UE 1300. UE 1300, under control of controller 280, transmits and receives signals via wireless radios 1301a-r and antennas 252a-r. Wireless radios 1301a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include capability information 1302 and uplink communication logic 1304. Capability information 1302 may include or correspond to capability information 320. Additionally, or alternatively, capability information 1302 may include first set of bands 321, second set of bands 322, switching time 324, state information 326, schedule information 238, configuration information 360. Uplink communication logic 1303 may be configured to perform one or more operations as described with reference to FIG. 2, 3, or 10-12. In some implementations, memory 282 may also include configuration information, such as first set of bands 321, second set of bands 322, switching time 324, state information 326, schedule information 238, configuration information 360, or a combination thereof. UE 1300 may receive signals from or transmit signals to one or more network entities, such as base station 105 of FIGS. 1-3 or a base station as illustrated in FIG. 15.

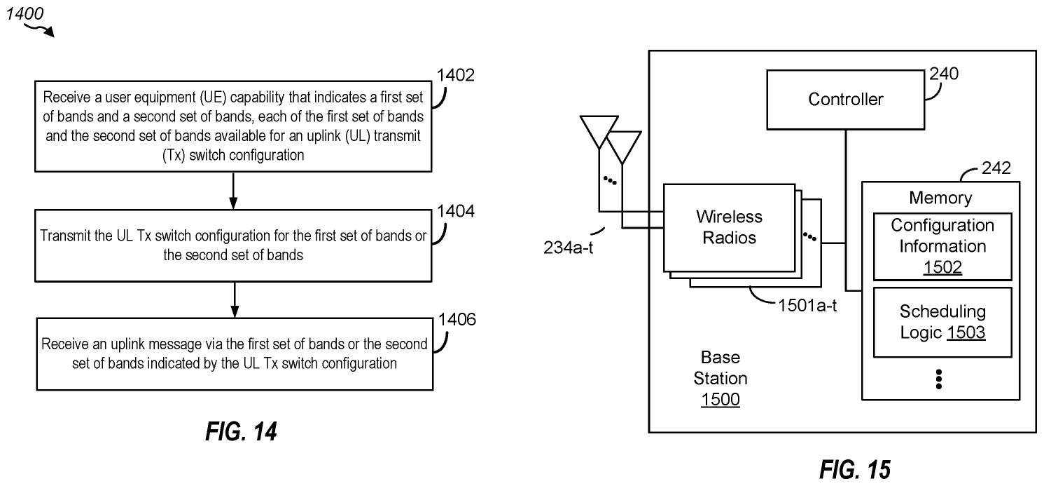

FIG. 14 is a flow diagram illustrating an example process 1400 that supports UL Tx switch operations according to one or more aspects. Operations of process 1400 may be performed by a base station, such as base station 105 described above with reference to FIGS. 1-3 or a base station as described above with reference to FIG. 15. For example, example operations of process 1400 may enable base station 105 to support UL Tx switch operations.

At block 1402, the base station receives a UE capability that indicates a first set of bands and a second set of bands, each of the first set of bands and the second set of bands available for a UL Tx switch configuration. For example, UE capability may include or correspond to capability message 380. The first set of bands and the second set of bands may include or correspond to first set of bands 321 and second set of bands 322, respectively. In some implementations, the UE capability indicates which sets of bands can be enabled simultaneously. Additionally, or alternatively, the UE capability may further indicates a maximum total number of Tx chains or a maximum total number of antenna ports in a set of bands, a maximum number of Tx chains or a maximum number of antenna ports in a set of bands, one or more fixed Tx chains or one or more fixed antenna ports in a set of bands, one or more distributable Tx chains or one or more distributable antenna ports in a set of bands, or a combination thereof.

At block 1404, the base station transmits the UL Tx switch configuration for the first set of bands or the second set of bands. For example, the UL Tx switch configuration may include or correspond to configuration message 382.

At block 1406, the base station receives an uplink message via the first set of bands or the second set of bands indicated by the UL Tx switch configuration. For example, the uplink message may include or correspond to first uplink message 384.

In some implementations, the first set of bands is a first band pair, and the second set of bands a second band pair. In some other implementations, the first set of bands includes a first group of one or more bands, and the second set of bands includes a second group of one or more bands.

In some implementations, the first set of bands includes a first set of carriers. To illustrate, the first set of carriers may include a first carrier of a first band, a second carrier of a second band, or a combination thereof. Additionally, in some implementations, the first band and the second band are the same band.

In some implementations, the first set of bands may include a first band, a first carrier of a second band, a first subcarrier of a third band, or a combination thereof. Accordingly, the first set of bands may include a combination of one or more bands, one or more carriers of one or more bands, one or more BWPs of one or more bands, one or more subcarriers of one or more bands, or a combination thereof. Additionally, or alternatively, the second set of bands may include a fourth band, a second carrier of a fifth band, a second subcarrier of a sixth band, or a combination thereof. Accordingly, the second set of bands may include a combination of one or more bands, one or more carriers of one or more bands, one or more BWPs of one or more bands, one or more subcarriers of one or more bands, or a combination thereof.

FIG. 15 is a block diagram of an example base station 1500 that supports UL Tx switch operations according to one or more aspects. Base station 1500 may be configured to perform operations, including the blocks of process 1400 described with reference to FIG. 14. In some implementations, base station 1500 includes the structure, hardware, and components shown and described with reference to base station 105 of FIGS. 1-3. For example, base station 1500 may include controller 240, which operates to execute logic or computer instructions stored in memory 242, as well as controlling the components of base station 1500 that provide the features and functionality of base station 1500. Base station 1500, under control of controller 240, transmits and receives signals via wireless radios 1501a-t and antennas 734a-t. Wireless radios 1501a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include configuration information 1502 and scheduling logic 1503. Configuration information 1502 may include or correspond to configuration information 360. Scheduling logic 703 may be configured to perform one or more operations as described with reference to FIG. 3 or 14. For example, scheduling logic 703 may be configured to generate scheduling information 362, determine a UL Tx switch configuration, schedule a UL communication, or a combination thereof. Base station 1500 may receive signals from or transmit signals to one or more UEs, such as UE 115 of FIGS. 1-3 or UE 1300 of FIG. 13.

It is noted that one or more blocks (or operations) described with reference to FIG. 10-12 or 14 may be combined with one or more blocks (or operations) described with reference to another of the figures. For example, one or more blocks (or operations) of FIG. 10 may be combined with one or more blocks (or operations) of FIG. 11 or 12. To illustrate, one or more operations described with reference to FIG. 10 may be performed prior to or subsequent to one or more operations of FIG. 11 or 12. As another example, one or more blocks associated with FIG. 11 may be combined with one or more blocks associated with FIG. 12. As another example, one or more blocks associated with FIG. 10-12 or 14 may be combined with one or more blocks (or operations) associated with FIGS. 1-3. Additionally, or alternatively, one or more operations described above with reference to FIGS. 1-3 may be combined with one or more operations described with reference to FIG. 13 or 15.

In some aspects, techniques for supporting UL Tx switch operations may include additional aspects, such as any single aspect or any combination of aspects described below or in connection with one or more other processes or devices described elsewhere herein. In a first aspect, techniques for UL Tx switch operations may include transmitting a UE capability that indicates a first set of bands and a second set of bands, and receiving a UL Tx switch configuration for the first set of bands or the second set of bands. The techniques further include transmitting an uplink message via the first set of bands or the second set of bands indicated by the UL Tx switch configuration. In some examples, the techniques in the first aspect may be implemented in a method or process. In some other examples, the techniques of the first aspect may be implemented in a wireless communication device such as a UE, a component of a UE, a network entity, or a component of a network entity. In some examples, the wireless communication device may include at least one processing unit or system (which may include an application processor, one or more processors, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include one or more means configured to perform operations described herein.

In a second aspect, in combination with the first aspect, the UE capability indicates a set of multiple bands including the first set of bands and the second set of bands, each set of bands of the set of multiple bands is available for the UL Tx switch configuration.

In a third aspect, in combination with the second aspect, the UE capability indicates which sets of bands can be enabled simultaneously.

In a fourth aspect, in combination with one or more of the first aspect through the third aspect, the first set of bands includes a first group of one or more bands, and the second set of bands includes a second group of three or more bands.

In a fifth aspect, in combination with the fourth aspect, the UE capability further indicates a third set of bands, a first switching time for the first set of bands, a second switching time for the second set of bands, a maximum total number of Tx chains or a maximum total number of antenna ports in a band pair or a set of bands, a maximum number of Tx chains or a maximum number of antenna ports in a band pair or a set of bands, one or more fixed Tx chains or one or more fixed antenna ports in a band pair or a set of bands, one or more distributable Tx chains or one or more distributable antenna ports in a band pair or a set of bands, or a combination thereof.

In a sixth aspect, in combination with one or more of the first aspect through the fifth aspect, the first set of bands includes a first band pair, and the second set of bands includes a second band pair.

In a seventh aspect, in combination with the first aspect, the first band pair includes a first carrier of a first band and a second carrier of a second band.

In an eighth aspect, in combination with the seventh aspect, a first band is included in each of the first group of one or more bands and the second group of one or more bands; a second band is included in each of the first group of one or more bands and the second group of one or more bands; or a combination thereof.

In a ninth aspect, in combination with the seventh aspect, the first group of one or more bands includes a first band and a first number of ports allocated to the first band, and the second group includes a second band and a second number of ports allocated to the second band.

In a tenth aspect, in combination with the ninth aspect, the first band and the second band are the same band, the first number of ports is different from the second number of ports, or a combination thereof.

In an eleventh aspect, in combination with one or more of the first aspect through the tenth aspect, the techniques further include storing, at a memory and based on the received UL Tx switch configuration, first data to indicate that the first set of bands is to be used for uplink communication.

In a twelfth aspect, in combination with the eleventh aspect, the techniques further include configuring a Tx chain, a port, or a combination thereof, to enable uplink communication via the first set of bands.

In a thirteenth aspect, in combination with the twelfth aspect, the UL Tx switch configuration is for the first set of bands and the uplink message is transmitted via the first set of bands based on the UL Tx switch configuration.

In a fourteenth aspect, in combination with one or more of the eleventh aspect through the thirteenth aspect, the techniques further include, after transmitting the uplink message via the first set of bands, receiving DCI to schedule a transmission via the second set of bands.

In a fifteenth aspect, in combination with the fourteenth aspect, the techniques further include transmitting, based on the DCI, a second uplink message via the second set of bands.

In a sixteenth aspect, in combination with the fifteenth aspect, the techniques further include switching, based on the DCI, from a first uplink communication configuration for the first set of bands to a second uplink communication configuration for the second set of bands.

In a seventeenth aspect, in combination with the sixteenth aspect, the techniques for switching from first uplink communication configuration to the second uplink communication configuration include: updating the memory to store second data indicating that the second set of bands is to be used for uplink communication; configuring the Tx chain, the port, or a combination thereof to enable uplink communication via the second set of bands; or a combination thereof.

In an eighteenth aspect, in combination with one or more of the firth aspect through the seventeenth aspect, the techniques further include transmitting a second uplink communication during a switching period associated with switching from the first set of bands to the second set of bands when the second uplink communication transmission is scheduled for transmission via a band included in both the first set of bands and the second set of bands.

In a nineteenth aspect, in combination with the eighteenth aspect, no uplink transmissions are scheduled for the UE during the switching period associated with switching from the first set of bands to the second set of bands or a scheduled transmission for the UE during the switching period is dropped and not transmitted.

In some aspects, techniques for supporting UL Tx switch operations may include additional aspects, such as any single aspect or any combination of aspects described below or in connection with one or more other processes or devices described elsewhere herein. In a twentieth aspect, techniques for supporting UL Tx switch operations may include receiving a UE capability that indicates a first set of bands and a second set of bands, each of the first set of bands and the second set of bands available for a UL Tx switch configuration; and transmitting the UL Tx switch configuration for the first set of bands or the second set of bands. The techniques further receiving an uplink message via the first set of bands or the second set of bands indicated by the UL Tx switch configuration. In some examples, the techniques in the twentieth aspect may be implemented in a method or process. In some other examples, the techniques of the twentieth aspect may be implemented in a wireless communication device such as a base station, a component of a base station, a network entity, or a component of a network entity. In some examples, the wireless communication device may include at least one processing unit or system (which may include an application processor, one or more processors, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include one or more means configured to perform operations described herein.

In a twenty-first aspect, in combination with the twentieth aspect, the first set of bands is a first band pair, and the second set of bands a second band pair.

In a twenty-second aspect, in combination with one or more of the twentieth aspect or the twenty-first aspect, the first set of bands includes a first group of one or more bands, and the second set of bands includes a second group of one or more bands.

In a twenty-third aspect, in combination with one or more of the twentieth aspect through the twenty-second aspect, the UE capability indicates which sets of bands can be enabled simultaneously, a maximum total number of Tx chains or a maximum total number of antenna ports in a set of bands, a maximum number of Tx chains or a maximum number of antenna ports in a set of bands, one or more fixed Tx chains or one or more fixed antenna ports in a set of bands, one or more distributable Tx chains or one or more distributable antenna ports in a set of bands, or a combination thereof.

In a twenty-fourth aspect, in combination with one or more of the twentieth aspect through the twenty-third, the first set of bands includes a first set of carriers.

In a twenty-fifth aspect, in combination with the twenty-fourth aspect, the first set of carriers includes a first carrier of a first band, a second carrier of a second band, or a combination thereof.

In a twenty-sixth aspect, in combination with the twenty-fourth aspect, the first set of bands and the second set of bands include at least one same band.

In some aspects, techniques for supporting UL Tx switch operations may include additional aspects, such as any single aspect or any combination of aspects described below or in connection with one or more other processes or devices described elsewhere herein. In a twenty-seventh aspect, techniques for UL Tx switch operations may include transmitting a UE capability that indicates a first band pair and a second band pair; and receiving an UL Tx switch configuration for the first band pair or the second band pair. The techniques further include transmitting an uplink message via the first band pair or the second band pair indicated by the UL Tx switch configuration. In some examples, the techniques in the twenty-seventh aspect may be implemented in a method or process. In some other examples, the techniques of the twenty-seventh aspect may be implemented in a wireless communication device such as a UE, a component of a UE, a network entity, or a component of a network entity. In some examples, the wireless communication device may include at least one processing unit or system (which may include an application processor, one or more processors, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include one or more means configured to perform operations described herein.

In a twenty-eighth aspect, in combination with the twenty-seventh aspect, the UE capability indicates which set of pairs can be enabled simultaneously.

In a twenty-ninth aspect, in combination with one or more of the twenty-seventh aspect or the twenty-eighth aspect, the UE capability indicates a first switching time for the first band pair, a second switching time for the second band pair, or a combination thereof.

In a thirtieth aspect, in combination with the twenty-seventh aspect, the UL Tx switch configuration is for the first band pair and the uplink message is transmitted via the first band pair based on the UL Tx switch configuration.

In a thirty-first aspect, in combination with one or more of the twenty-seventh aspect through the thirtieth aspect, the techniques further include storing, at a memory and based on the received UL Tx switch configuration, first data to indicate that the first band pair is to be used for uplink communication.

In a thirty-second aspect, in combination with one or more of the twenty-seventh aspect through the thirty-first aspect, the techniques further include configuring a Tx chain, a port, or a combination thereof, to enable uplink communication via the first band pair.

In a thirty-third aspect, in combination with one or more of the thirtieth aspect or the thirty-first aspect, the techniques further include, after transmitting the uplink message via the first band pair, receiving DCI to schedule a transmission via the second band pair.

In a thirty-fourth aspect, in combination with the thirty-third aspect, the techniques further include transmitting, based on the DCI, a second uplink message via the second band pair.

In a thirty-fifth aspect, in combination with one or more of the thirty-third aspect or the thirty-fourth aspect, the techniques further include switching, based on the DCI, from a first uplink communication configuration for the first band pair to a second uplink communication configuration for the second band pair.

In a thirty-sixth aspect, in combination with the thirty-fifth aspect, the techniques for switching from first uplink communication configuration to the second uplink communication configuration include: updating the memory to store second data indicating that the second band pair is to be used for uplink communication; configuring the Tx chain, the port, or a combination thereof to enable uplink communication via the second band pair; or a combination thereof.

In a thirty-seventh aspect, in combination with one or more of the thirty-third aspect through the thirty-sixth aspect, no uplink transmissions are scheduled for the UE during a switching period associated with switching from the first band pair to the second band pair or a scheduled transmission for the UE during the switching period is dropped and not transmitted.

In a thirty-eighth aspect, in combination with one or more of the thirty-third aspect through the thirty-seventh aspect the techniques further include transmitting a second uplink communication during a switching period associated with switching from the first band pair to the second band pair when the second uplink communication transmission is scheduled for transmission via a band included in both the first band pair and the second band pair.

In a thirty-ninth aspect, in combination with one or more of the twenty-seventh aspect through the thirty-eighth aspect, the first band pair includes a first band and a second band, and the second band pair includes a third band and a fourth band.

In a fortieth aspect, in combination with the thirty-ninth aspect, the second band and the third band are the same band.

In a forty-first aspect, in combination with the thirty-ninth aspect, the UE capability further indicates a third band pair, the third band pair including a fifth band and a sixth band.

In a forty-second aspect, in combination with the forty-first aspect, the second band and the fifth band are the same band, the third band and the sixth band are the same band, or a combination thereof.

In a forty-third aspect, in combination with the twenty-seventh aspect, the first band pair includes a first carrier of a first band and a second carrier of a second band.

In a forty-fourth aspect, in combination with the forty-third aspect, the first band and the second band are the same band.

In some aspects, techniques for supporting UL Tx switch operations may include additional aspects, such as any single aspect or any combination of aspects described below or in connection with one or more other processes or devices described elsewhere herein. In a forty-fifth aspect, techniques for UL Tx switch operations may include transmitting a UE capability that indicates a first set of bands and a second set of bands, and receiving a UL Tx switch configuration for the first set of bands or the second set of bands. The techniques further include transmitting an uplink message via the first set of bands or the second set of bands indicated by the UL Tx switch configuration. In some examples, the techniques in the forty-fifth aspect may be implemented in a method or process. In some other examples, the techniques of the forty-fifth aspect may be implemented in a wireless communication device such as a UE, a component of a UE, a network entity, or a component of a network entity. In some examples, the wireless communication device may include at least one processing unit or system (which may include an application processor, one or more processors, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include one or more means configured to perform operations described herein.

In a forty-sixth aspect, in combination the forty-fifth aspect, the UE capability indicates a set of multiple bands including the first set of bands and the second set of bands, each set of bands of the set of multiple bands is available for the UL Tx switch configuration.

In a forty-seventh aspect, in combination with one or more of the forty-fifth aspect or the forty-sixth aspect, the UE capability indicates which sets of bands can be enabled simultaneously.

In a forty-eighth aspect, in combination with one or more of the forty-fifth aspect through the forty-seventh aspect, the first set of bands includes a first group of one or more bands, and the second set of bands includes a second group of one or more bands.

In a forty-ninth aspect, in combination with the forty-fifth aspect, the first group of one or more bands includes a single band, and the second group of one or more bands includes two or more bands.

In a fiftieth aspect, in combination with the forty-fifth aspect, each of the first group of one or more bands and the second group of one or more bands includes multiple bands.

In a fifty-first aspect, in combination with one or more of the forty-fifth aspect through the fiftieth aspect, the UE capability further indicates a third set of bands.

In a fifty-second aspect, in combination with one or more of the forty-eighth aspect through the fifty-first aspect, the second group of bands includes three or more bands.

In a fifty-third aspect, in combination with one or more of the forty-eighth aspect through the fifty-second aspect, a first band is included in each of the first group of one or more bands and the second group of one or more bands.

In a fifty-fourth aspect, in combination the fifty-third aspect, a second band is included in each of the first group of one or more bands and the second group of one or more bands.

In a fifty-fifth aspect, in combination with one or more of the forty-eighth aspect through the fifty-second aspect, the first group of one or more bands includes a first band and a first number of ports allocated to the first band, and the second group includes a second band and a second number of ports allocated to the second band.

In a fifty-sixth aspect, in combination with the fifty-fifth aspect, the first band and the second band are the same band, the first number of ports is different from the second number of ports, or a combination thereof.

In a fifty-seventh aspect, in combination with one or more of the forty-fifth aspect through the fifty-sixth aspect, the UE capability indicates a first switching time for the first set of bands, a second switching time for the second set of bands, or a combination thereof.

In a fifty-eighth aspect, in combination with one or more of the forty-fifth aspect through the fifty-seventh aspect, the UL Tx switch configuration is for the first set of bands and the uplink message is transmitted via the first set of bands based on the UL Tx switch configuration.

In a fifty-ninth aspect, in combination with one or more of the forty-fifth aspect through the fifty-eighth aspect, the techniques further include storing, at a memory and based on the received UL Tx switch configuration, first data to indicate that the first set of bands is to be used for uplink communication.

In a sixtieth aspect, in combination with one or more of the forty-fifth aspect through the thirty-seventh aspect, the techniques further include configuring a Tx chain, a port, or a combination thereof, to enable uplink communication via the first set of bands.

In a sixty-first aspect, in combination with one or more of the fifty-ninth aspect or the fifty-ninth aspect, the techniques further include, after transmitting the uplink message via the first set of bands, receiving DCI to schedule a transmission via the second set of bands.

In a sixty-second aspect, in combination with the sixty-first aspect, the techniques further include transmitting, based on the DCI, a second uplink message via the second set of bands.

In a sixty-third aspect, in combination with one or more of the sixty-first aspect or the sixty-second aspect, the techniques further include switching, based on the DCI, from a first uplink communication configuration for the first set of bands to a second uplink communication configuration for the second set of bands.

In a sixty-fourth aspect, in combination with the sixty-third aspect, the techniques for switching from first uplink communication configuration to the second uplink communication configuration include updating the memory to store second data indicating that the second set of bands is to be used for uplink communication; configuring the Tx chain, the port, or a combination thereof to enable uplink communication via the second set of bands; or a combination thereof.

In a sixty-fifth aspect, in combination with one or more of the forty-fifth aspect through the sixty-fourth aspect, no uplink transmissions are scheduled for the UE during a switching period associated with switching from the first set of bands to the second set of bands or a scheduled transmission for the UE during the switching period is dropped and not transmitted.

In a sixty-sixth aspect, in combination with one or more of the forty-fifth aspect through the sixty-fourth aspect, the techniques further include transmitting a second uplink communication during a switching period associated with switching from the first set of bands to the second set of bands when the second uplink communication transmission is scheduled for transmission via a band included in both the first set of bands and the second set of bands.

In a sixty-seventh aspect, in combination with one or more of the forty-fifth aspect through the sixty-sixth aspect, the UE capability further indicates a maximum total number of Tx chains or a maximum total number of antenna ports in a band pair or a set of bands, a maximum number of Tx chains or a maximum number of antenna ports in a band pair or a set of bands, one or more fixed Tx chains or one or more fixed antenna ports in a band pair or a set of bands, one or more distributable Tx chains or one or more distributable antenna ports in a band pair or a set of bands, or a combination thereof.

In a sixty-eighth aspect, in combination with the forty-fifth aspect, the first set of bands includes a first set of carriers.

In a sixty-ninth aspect, in combination with the sixty-eighth aspect, the first set of carriers includes a first carrier of a first band, a second carrier of a second band, or a combination thereof.

In a seventieth aspect, in combination with the sixty-eighth aspect, the first band and the second band are the same band.

In some aspects, techniques for supporting UL Tx switch operations may include additional aspects, such as any single aspect or any combination of aspects described below or in connection with one or more other processes or devices described elsewhere herein. In a seventy-first aspect, techniques for supporting UL Tx switch operations may include receiving a UE capability that indicates a first set of bands and a second set of bands, each of the first set of bands and the second set of bands available for a UL Tx switch configuration; and transmitting the UL Tx switch configuration for the first set of bands or the second set of bands. The techniques further receiving an uplink message via the first set of bands or the second set of bands indicated by the UL Tx switch configuration. In some examples, the techniques in the seventy-first aspect may be implemented in a method or process. In some other examples, the techniques of the seventy-first aspect may be implemented in a wireless communication device such as a base station, a component of a base station, a network entity, or a component of a network entity. In some examples, the wireless communication device may include at least one processing unit or system (which may include an application processor, one or more processors, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include one or more means configured to perform operations described herein.

In a seventy-second aspect, in combination with the seventy-first aspect, the UE capability indicates which sets of bands can be enabled simultaneously.

In a seventy-third aspect, in combination with one or more of the seventy-first aspect or the seventy-second aspect, the first set of bands is a first band pair, and the second set of bands a second band pair.

In a seventy-fourth aspect, in combination with one or more of the seventy-first aspect or the seventy-second aspect, the first set of bands includes a first group of one or more bands, and the second set of bands includes a second group of one or more bands.

In a seventy-fifth aspect, in combination with one or more of the seventy-first aspect through the seventy-fourth aspect the UE capability further indicates a maximum total number of Tx chains or a maximum total number of antenna ports in a set of bands, a maximum number of Tx chains or a maximum number of antenna ports in a set of bands, one or more fixed Tx chains or one or more fixed antenna ports in a set of bands, one or more distributable Tx chains or one or more distributable antenna ports in a set of bands, or a combination thereof.

In a seventy-sixth aspect, in combination with one or more of the seventy-first aspect through the seventy-fifth aspect, the first set of bands includes a first set of carriers.

In a seventy-seventh aspect, in combination with the seventy-sixth aspect, the first set of carriers includes a first carrier of a first band, a second carrier of a second band, or a combination thereof.

In a seventy-eighth aspect, in combination with the seventy-sixth aspect, the first band and the second band are the same band.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-15 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a user equipment (UE), the method comprising:
transmitting a UE capability that indicates a first set of bands and a second set of bands;
receiving an uplink (UL) transmit (Tx) switch configuration for the first set of bands or the second set of bands; and
transmitting an uplink message via the first set of bands or the second set of bands indicated by the UL Tx switch configuration.

2. The method of claim 1, wherein:
the UE capability indicates a set of multiple bands including the first set of bands and the second set of bands, each set of bands of the set of multiple bands is available for the UL Tx switch configuration; and
the UE capability indicates which sets of bands can be enabled simultaneously.

3. The method of claim 1, wherein:
the first set of bands includes a first group of one or more bands, and the second set of bands includes a second group of one or more bands; and
the UE capability further indicates a third set of bands, a first switching time for the first set of bands, a second switching time for the second set of bands, a maximum total number of Tx chains or a maximum total number of antenna ports in a band pair or a set of bands, a maximum number of Tx chains or a maximum number of antenna ports in a band pair or a set of bands, one or more fixed Tx chains or one or more fixed antenna ports in a band pair or a set of bands, one or more distributable Tx chains or one or more distributable antenna ports in a band pair or a set of bands, or a combination thereof.

4. The method of claim 3, wherein:
a first band is included in each of the first group of one or more bands and the second group of one or more bands;
a second band is included in each of the first group of one or more bands and the second group of one or more bands, the second group of one or more bands includes three or more bands; or
a combination thereof.

5. The method of claim 3, wherein:
the first group of one or more bands includes a first band and a first number of ports allocated to the first band, and the second group of one or more bands includes a second band and a second number of ports allocated to the second band; and
the first band and the second band are the same band, the first number of ports is different from the second number of ports, or a combination thereof.

6. The method of claim 1, wherein the first set of bands includes a first band pair, and the second set of bands includes a second band pair.

7. The method of claim 6, wherein the first band pair includes a first carrier of a first band and a second carrier of a second band.

8. The method of claim 1, further comprising:
storing, at a memory and based on the received UL Tx switch configuration, first data to indicate that the first set of bands is to be used for uplink communication; and
configuring a Tx chain, a port, or a combination thereof, to enable uplink communication via the first set of bands; and
wherein the UL Tx switch configuration is for the first set of bands and the uplink message is transmitted via the first set of bands based on the UL Tx switch configuration.

9. The method of claim 8, further comprising, after transmitting the uplink message via the first set of bands, receiving downlink control information (DCI) to schedule a transmission via the second set of bands.

10. The method of claim 9, further comprising:
transmitting, based on the DCI, a second uplink message via the second set of bands; and
switching, based on the DCI, from a first uplink communication configuration for the first set of bands to a second uplink communication configuration for the second set of bands; and
wherein switching from the first uplink communication configuration to the second uplink communication configuration includes:
updating the memory to store second data indicating that the second set of bands is to be used for uplink communication;
configuring the Tx chain, the port, or a combination thereof to enable uplink communication via the second set of bands; or
a combination thereof.

11. The method of claim 1, further comprising transmitting a second uplink communication during a switching period associated with switching from the first set of bands to the second set of bands when transmission of the second uplink communication is scheduled for transmission via a band included in both the first set of bands and the second set of bands; or
wherein no uplink transmissions are scheduled for the UE during the switching period associated with switching from the first set of bands to the second set of bands or a scheduled transmission for the UE during the switching period is dropped and not transmitted.

12. A user equipment (UE) comprising:
a memory storing processor-readable code; and
at least one processor coupled to the memory, the at least one processor configured to execute the processor-readable code to cause the at least one processor to:
initiate transmission of a UE capability that indicates a first set of bands and a second set of bands;
receive an uplink (UL) transmit (Tx) switch configuration for the first set of bands or the second set of bands; and
initiate transmission of an uplink message via the first set of bands or the second set of bands indicated by the UL Tx switch configuration.

13. The UE of claim 12, wherein the UE capability indicates a set of multiple bands including the first set of bands and the second set of bands, each set of bands of the set of multiple bands is available for the UL Tx switch configuration.

14. The UE of claim 12, wherein the at least one processor is configured to execute the processor-readable code to cause the at least one processor to:
store, at a memory and based on the received UL Tx switch configuration, first data to indicate that the first set of bands is to be used for uplink communication; and
configure a Tx chain, a port, or a combination thereof, to enable uplink communication via the first set of bands; and
wherein the UL Tx switch configuration is for the first set of bands and the uplink message is transmitted via the first set of bands based on the UL Tx switch configuration.

15. The UE of claim 12, a first group of one or more bands includes a first band and a first number of ports allocated to the first band, and a second group includes a second band and a second number of ports allocated to the second band.

16. The UE of claim 12, wherein the at least one processor is configured to execute the processor-readable code to cause the at least one processor to:
after transmitting the uplink message via the first set of bands, receive downlink control information (DCI) to schedule a transmission via the second set of bands;
transmit, based on the DCI, a second uplink message via the second set of bands; and
switch, based on the DCI, from a first uplink communication configuration for the first set of bands to a second uplink communication configuration for the second set of bands.

17. The UE of claim 16, wherein the at least one processor is configured to execute the processor-readable code to cause the at least one processor to transmit a second uplink communication during a switching period associated with switching from the first set of bands to the second set of bands when transmission of the second uplink communication is scheduled for transmission via a band included in both the first set of bands and the second set of bands.

18. The UE of claim 16, wherein no uplink transmissions are scheduled for the UE during a switching period associated with switching from the first set of bands to the second set of bands or a scheduled transmission for the UE during the switching period is dropped and not transmitted.

19. A method of wireless communication performed by a base station, the method comprising:
receiving a user equipment (UE) capability that indicates a first set of bands and a second set of bands, each of the first set of bands and the second set of bands available for an uplink (UL) transmit (Tx) switch configuration;
transmitting the UL Tx switch configuration for the first set of bands or the second set of bands; and
receiving an uplink message via the first set of bands or the second set of bands indicated by the UL Tx switch configuration.

20. The method of claim 19, wherein the first set of bands is a first band pair, and the second set of bands a second band pair.

21. The method of claim 19, wherein the first set of bands includes a first group of one or more bands, and the second set of bands includes a second group of one or more bands.

22. The method of claim 19, wherein the UE capability indicates which sets of bands can be enabled simultaneously, a maximum total number of Tx chains or a maximum total number of antenna ports in a set of bands, a maximum number of Tx chains or a maximum number of antenna ports in a set of bands, one or more fixed Tx chains or one or more fixed antenna ports in a set of bands, one or more distributable Tx chains or one or more distributable antenna ports in a set of bands, or a combination thereof.

23. The method of claim 19, wherein the first set of bands includes a first set of carriers.

24. The method of claim 23, wherein the first set of carriers includes a first carrier of a first band, a second carrier of a second band, or a combination thereof.

25. The method of claim 23, wherein the first set of bands and the second set of bands include at least one same band.

26. A base station comprising:
a memory storing processor-readable code; and
at least one processor coupled to the memory, the at least one processor configured to execute the processor-readable code to cause the at least one processor to:
receive a user equipment (UE) capability that indicates a first set of bands and a second set of bands, each of the first set of bands and the second set of bands available for an uplink (UL) transmit (Tx) switch configuration;
initiate transmission of the UL Tx switch configuration for the first set of bands or the second set of bands; and
receive an uplink message via the first set of bands or the second set of bands indicated by the UL Tx switch configuration.

27. The base station of claim 26, wherein the first set of bands is a first band pair, and the second set of bands a second band pair.

28. The base station of claim 26, wherein:
the first set of bands includes a first group of one or more bands, and the second set of bands includes a second group of one or more bands; and
the UE capability indicates which sets of bands can be enabled simultaneously, a maximum total number of Tx chains or a maximum total number of antenna ports in a set of bands, a maximum number of Tx chains or a maximum number of antenna ports in a set of bands, one or more fixed Tx chains or one or more fixed antenna ports in a set of bands, one or more distributable Tx chains or one or more distributable antenna ports in a set of bands, or a combination thereof.

29. The base station of claim 26, wherein the first set of bands includes a first set of carriers, the first set of carriers includes a first carrier of a first band, a second carrier of a second band, or a combination thereof.

30. The base station of claim 26, wherein the first set of bands and the second set of bands include at least one same band.
